(19) United States
(12) Patent Application Publication
(10) Pub. No.: US 2019/0308807 A1
(43) Pub. Date: Oct. 10, 2019

(54) Easy Lid

(71) Applicant: Iram Yusuf, San Antonio, TX (US)

(72) Inventor: Iram Yusuf, San Antonio, TX (US)

(21) Appl. No.: 15/948,892

(22) Filed: Apr. 9, 2018

(51) Int. Cl. B65F 1/00; B65F 1/14; B65F 1/06; B65F 1/16

(52) U.S. Cl. CPC B65F 1/0006; B65F 1/163; B65F 1/06; B65F 1/1415

(57) ABSTRACT

The easy lid is a new invention because I have never seen anything in like it in the market. I created it for the sole purpose of keeping house hold use garbage bins' lids clean no matter what size or style they are. This invention can be used for any commercial garbage bins as well with size modifications.

### SPECIFICATION

This is a utility and design product for any and every garbage bin lid which can be lifted or picked up or removed and replaced back. This can be made to fit any lid of a foot operated garbage bin or one which has a lid that can be removed and replaced by hands or a garbage can with a simple lid that can be flipped open by hand and is partially attached to the garbage can. This product covers the lids of garbage bins so that they remain clean and are not soiled or made dirty from inside facing the garbage disposed of or outside facing away from the garbage. It can be made to cover the whole lid from inside and outside, and a handle can be attached to it as well made of the same material. It can be made to cover only the inside of the lid facing the garbage with an elastic rim or an adjustable one with a string to pull it to fit the size of the lid. This product can be made of any material which is usable in a domestic and/or commercial setting. Not limited to paper, plastic, fabric, metal, or any combination thereof. This product is available and can be made in different colors encompassing the entire color spectrum.

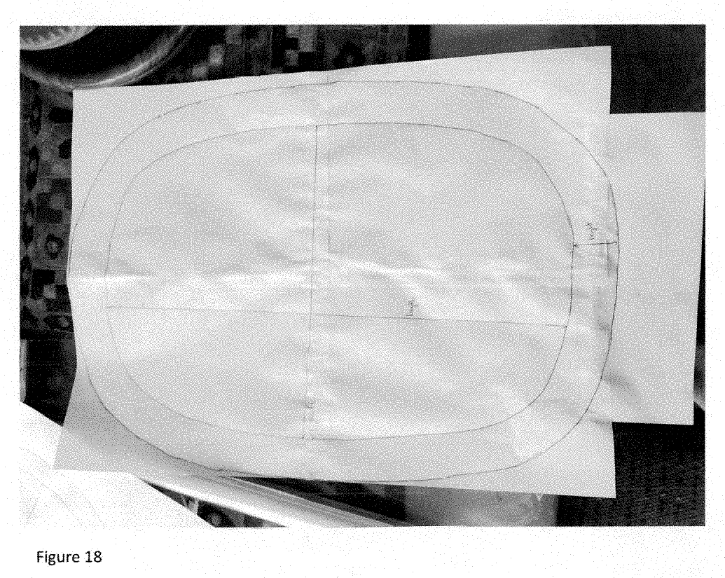

The description below of the individual figures is added text, and FIGS. 18 to 23 have been added for clarification of the invention.

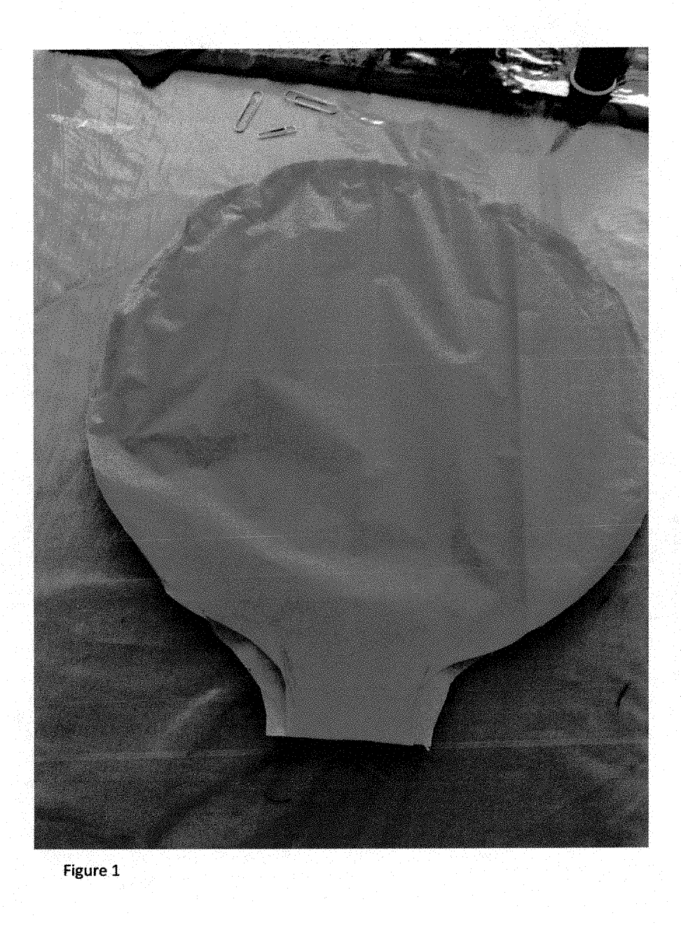

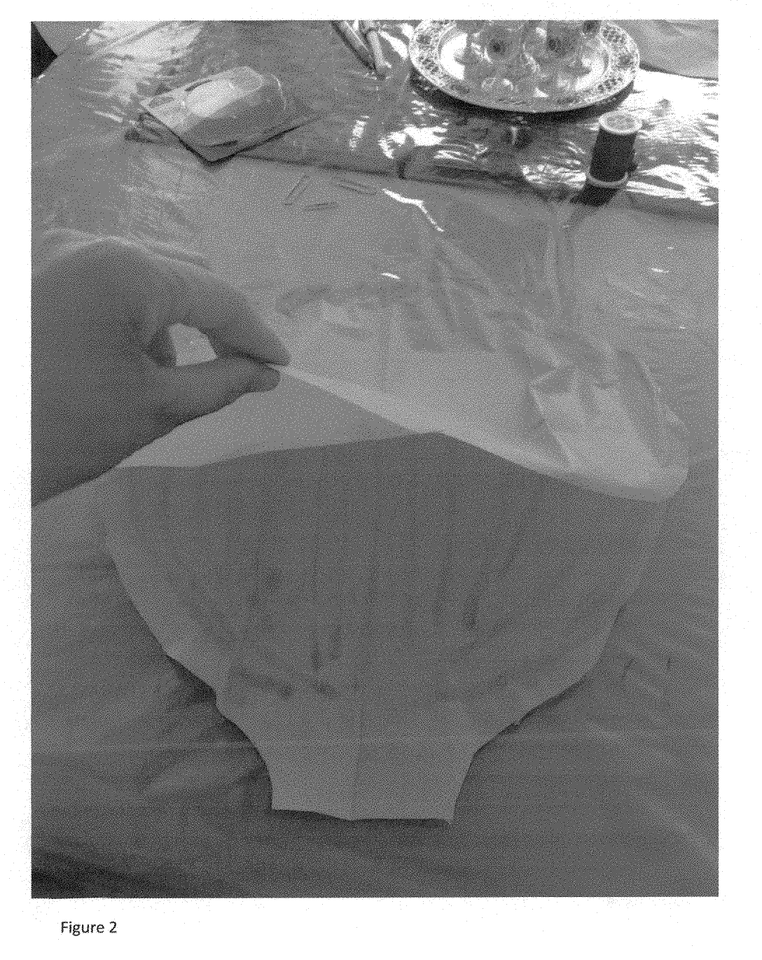

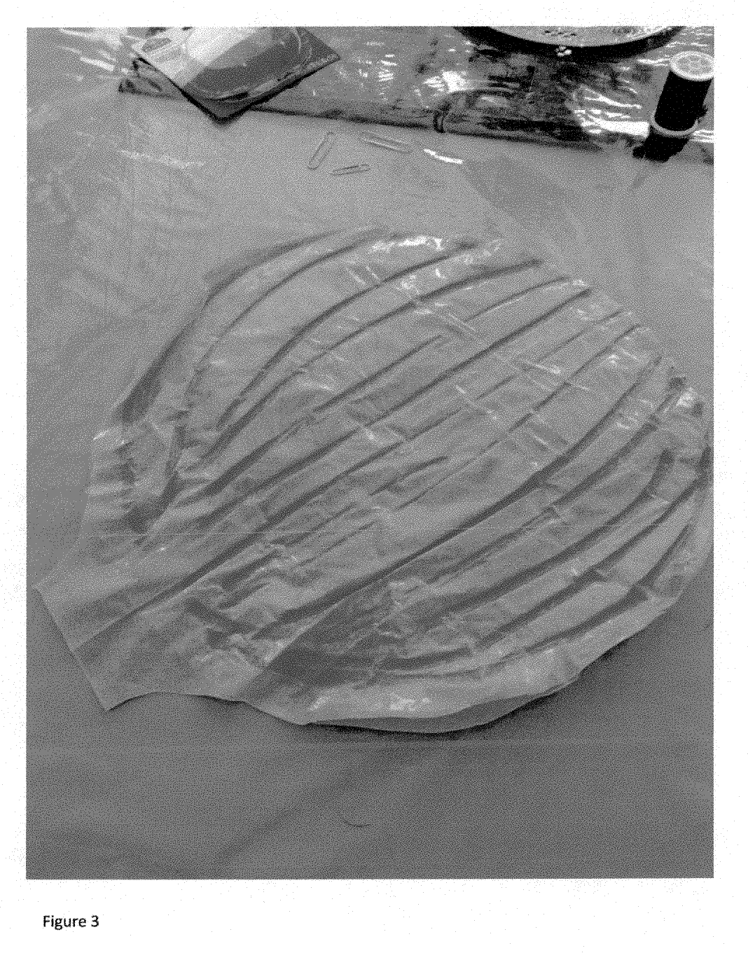

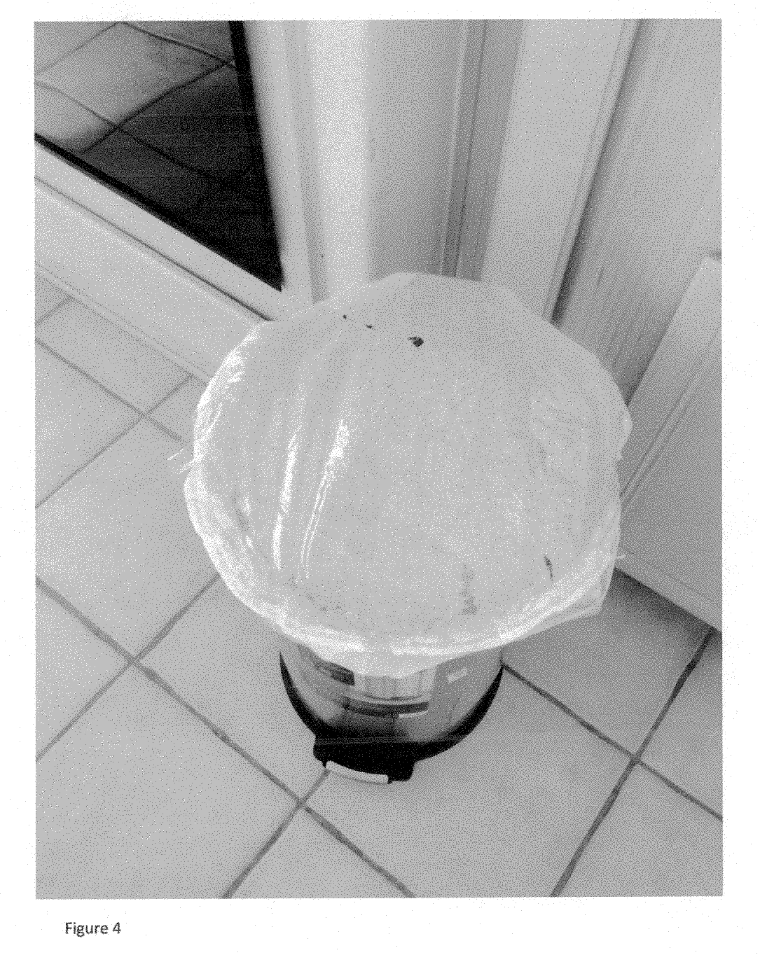

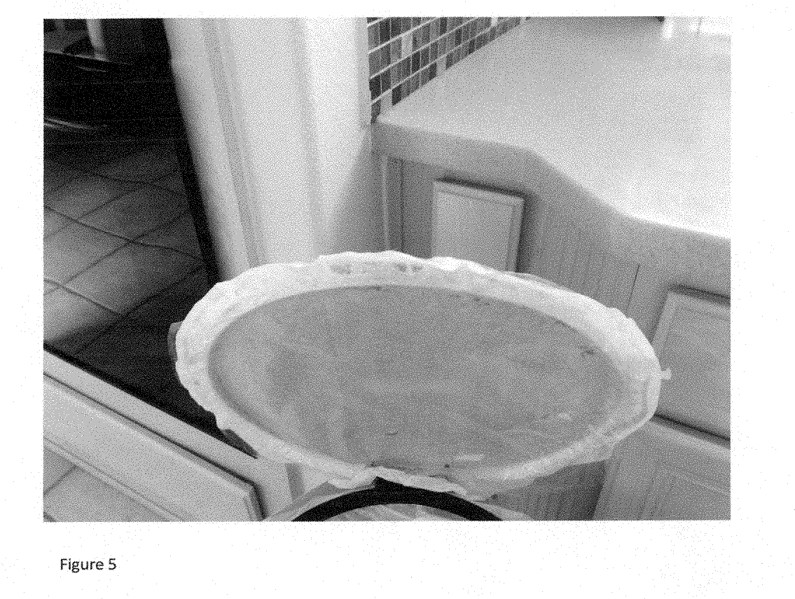

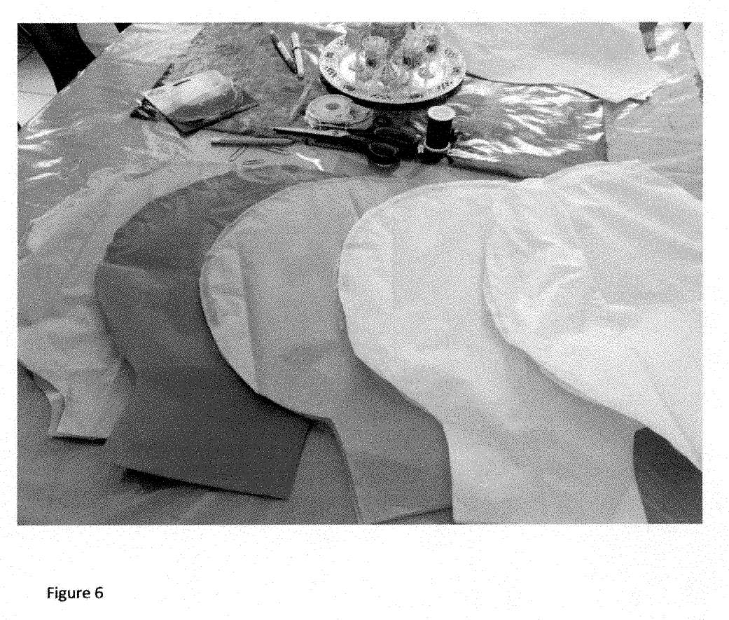

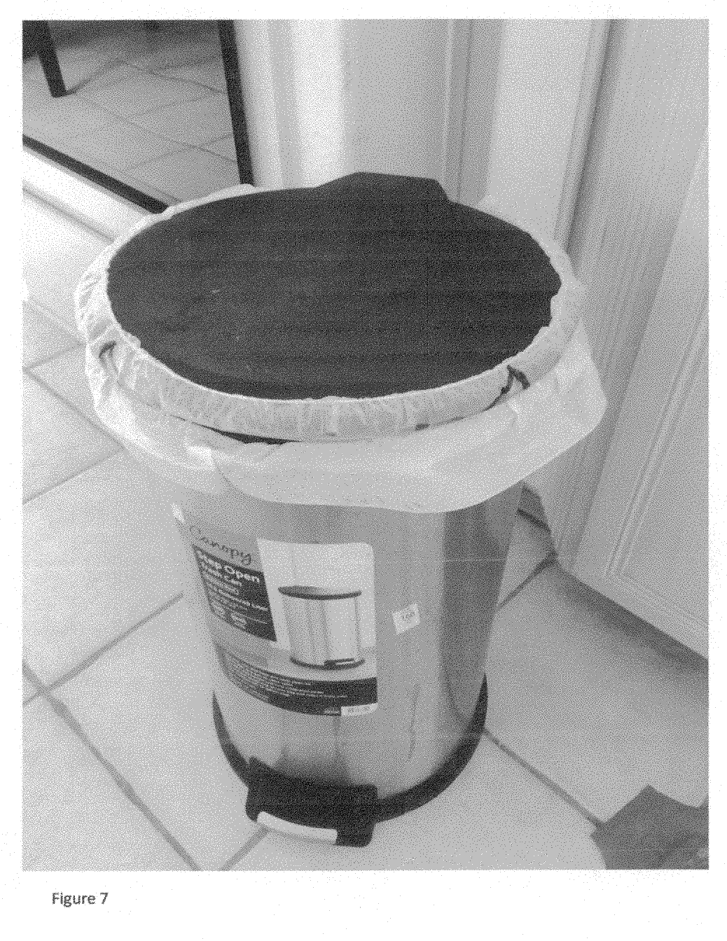

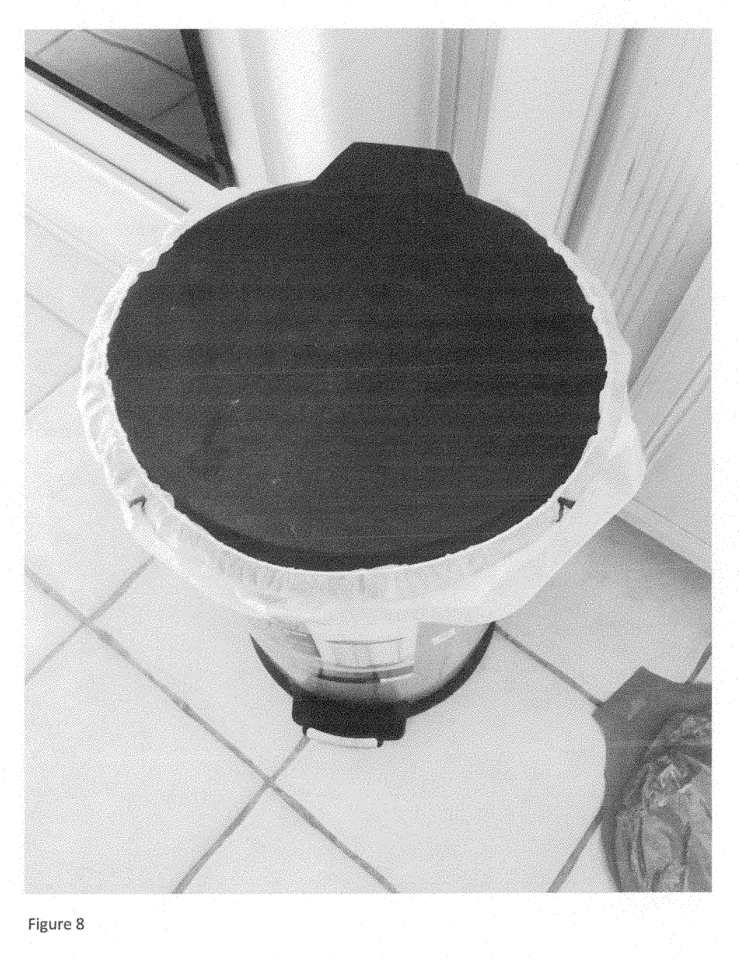

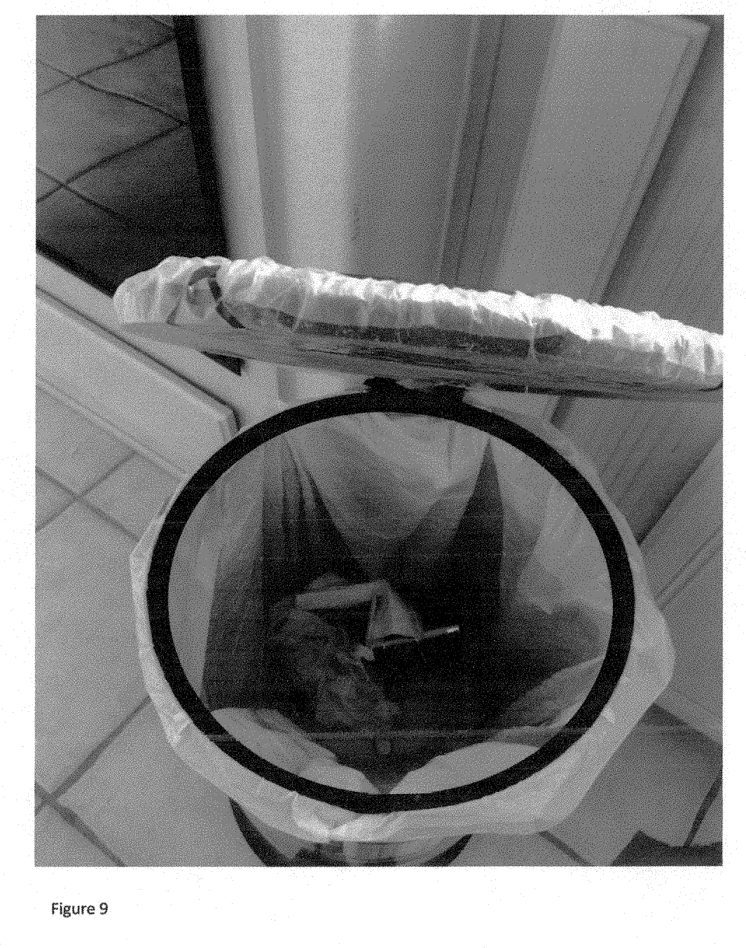

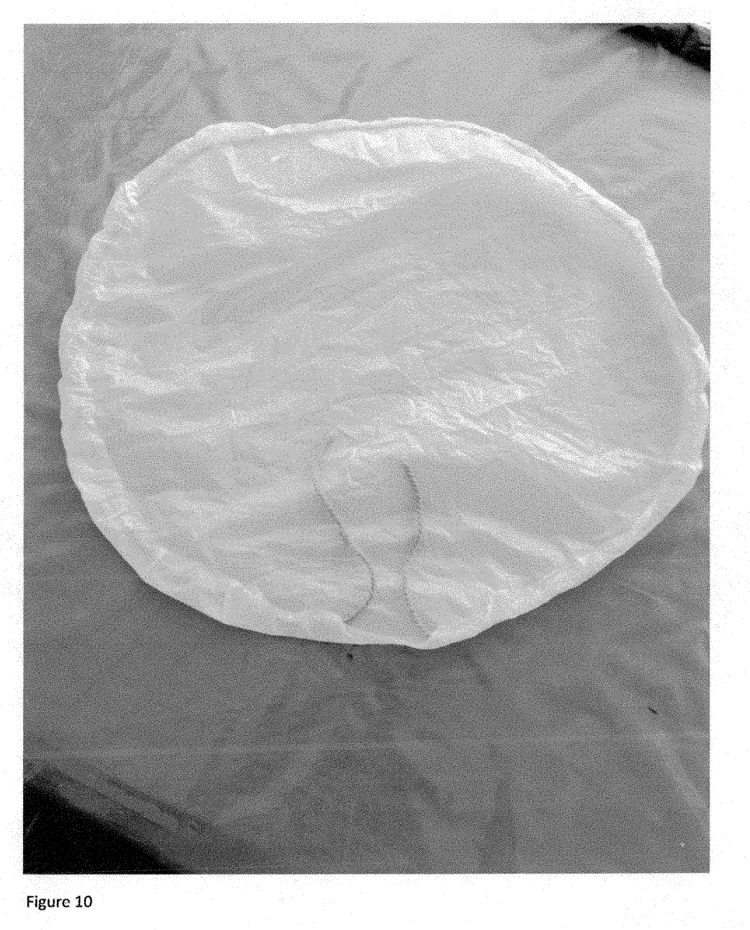

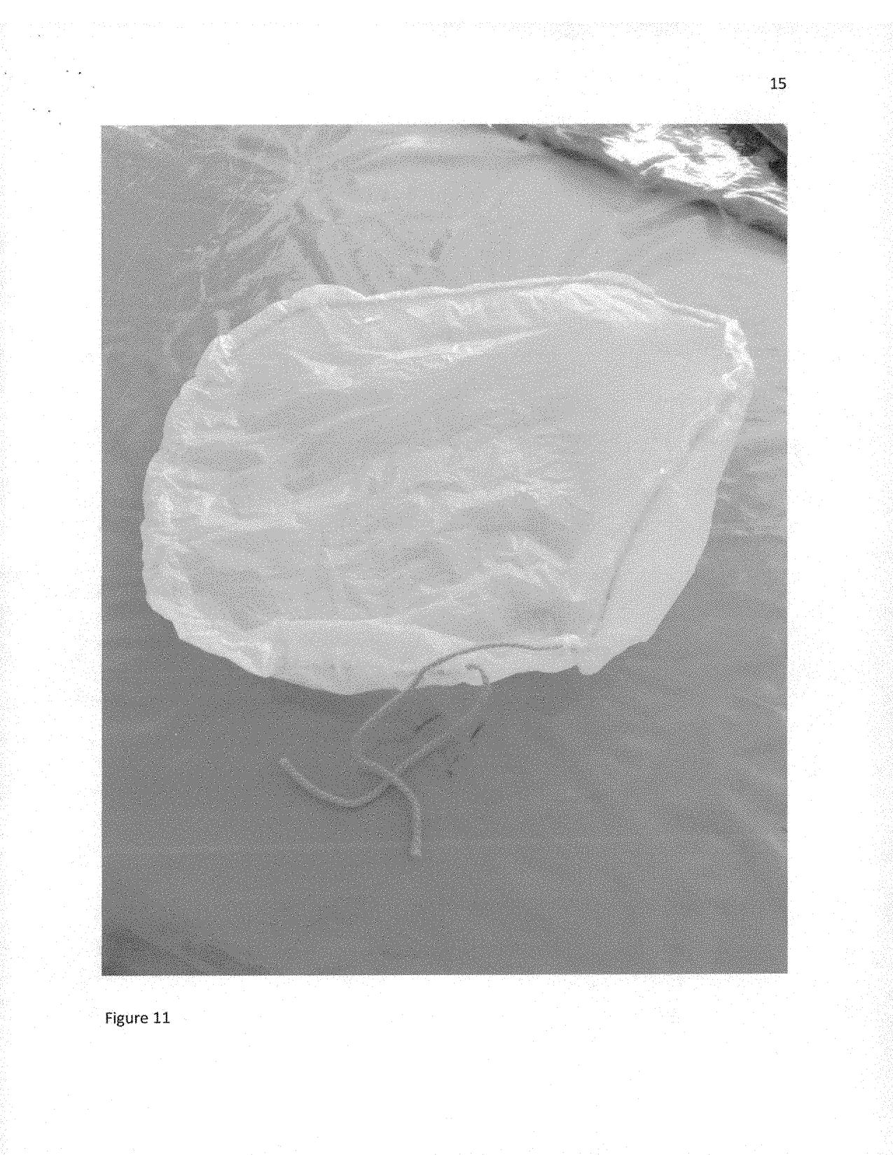

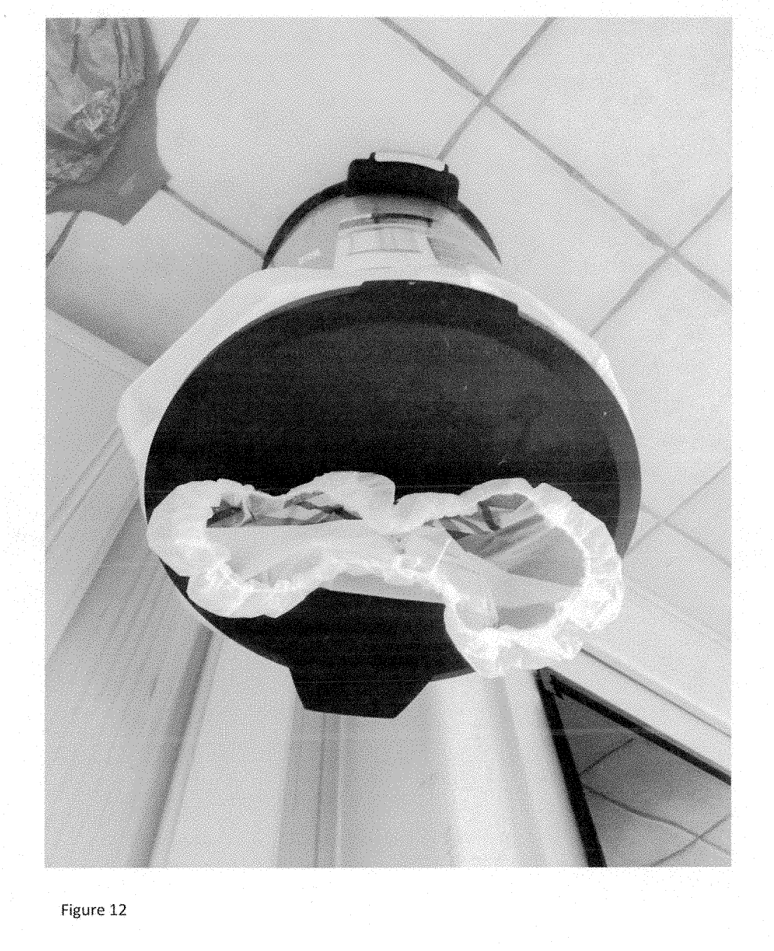

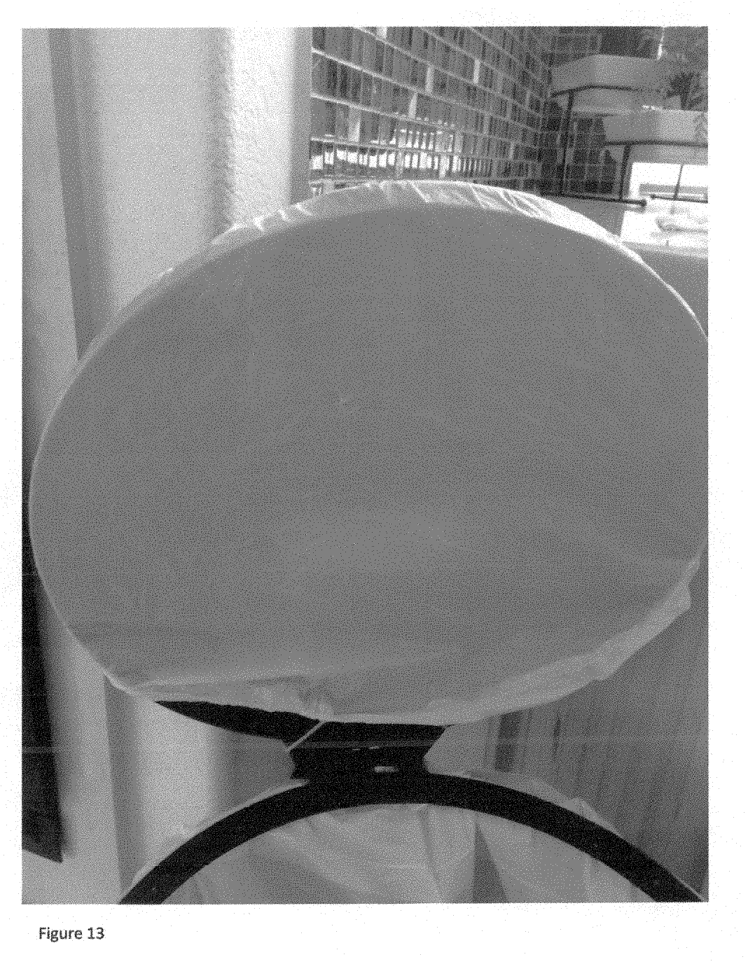

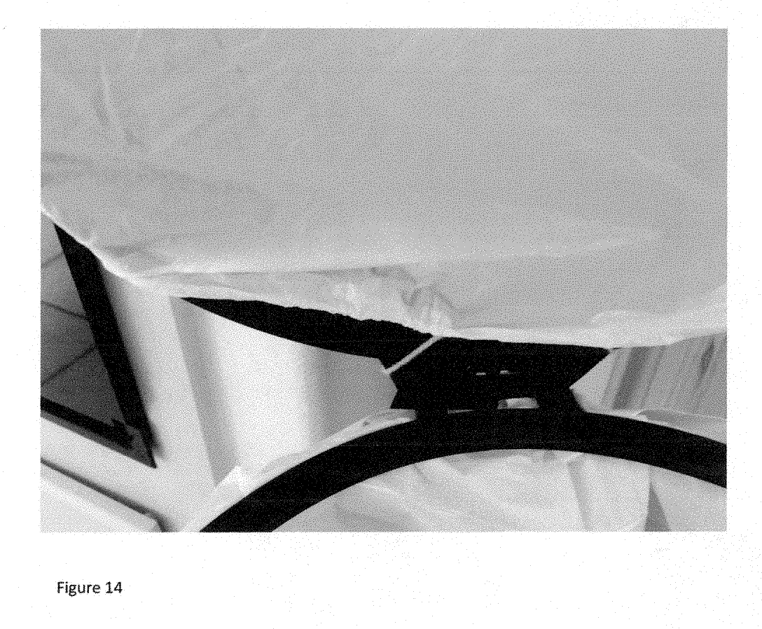

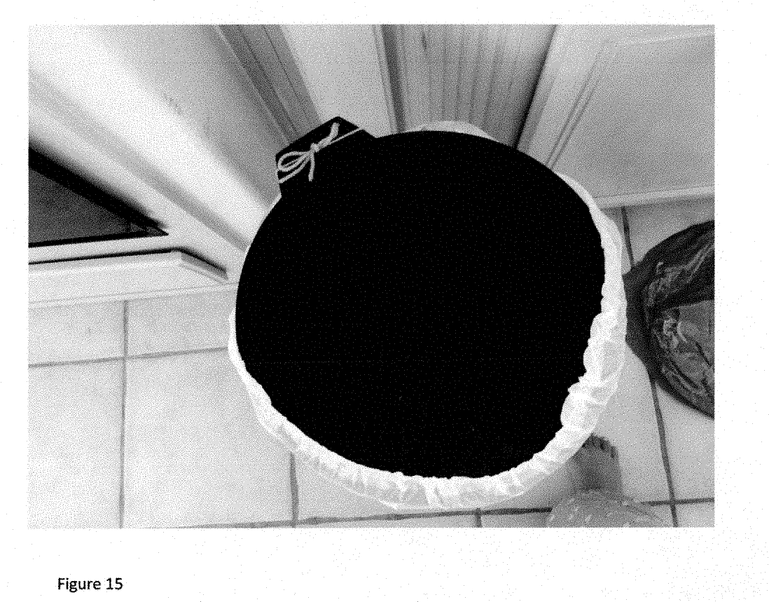

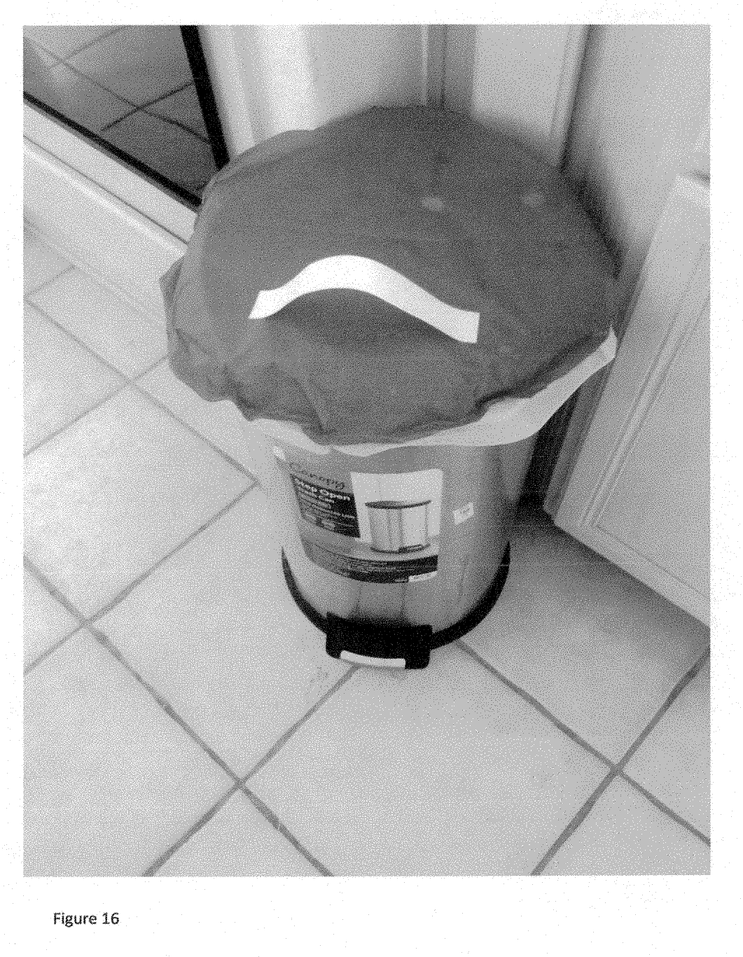

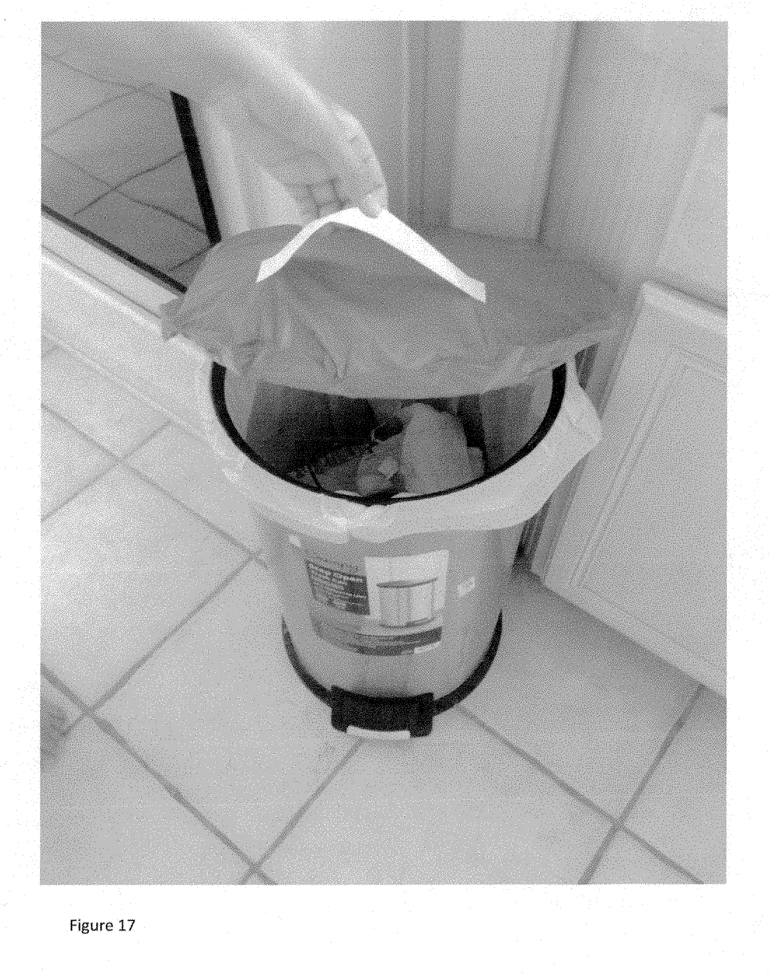

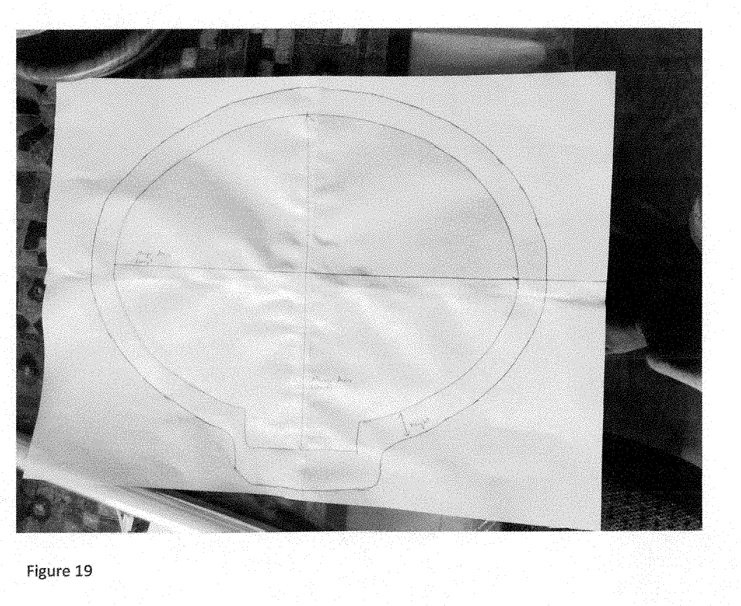

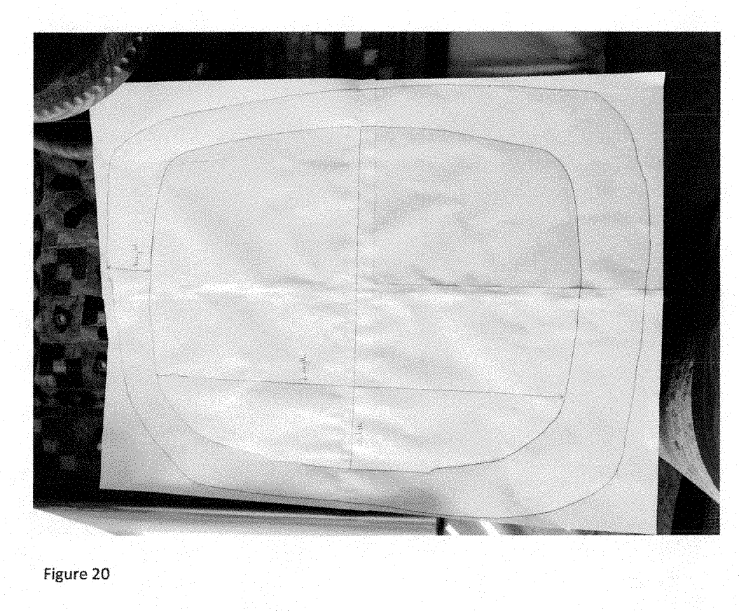

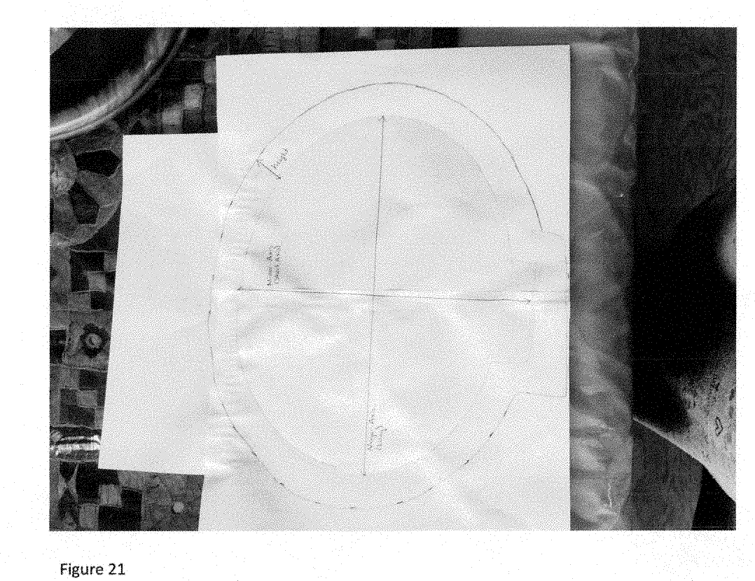

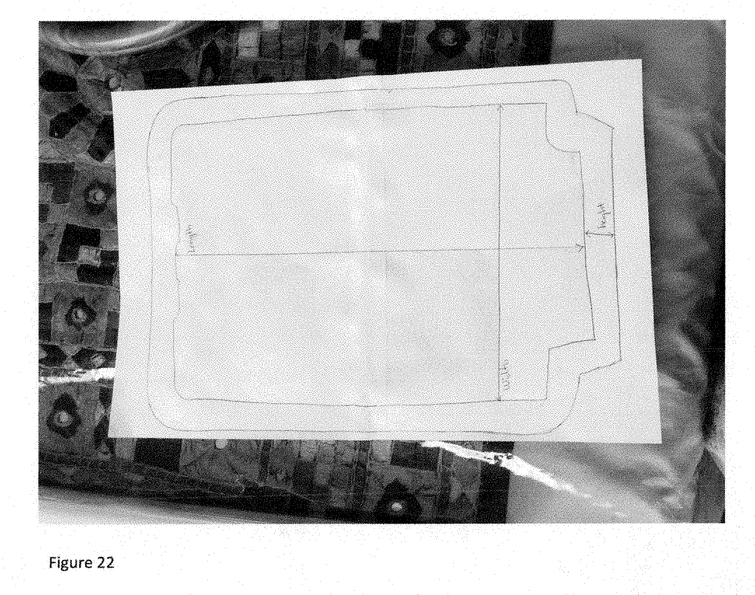

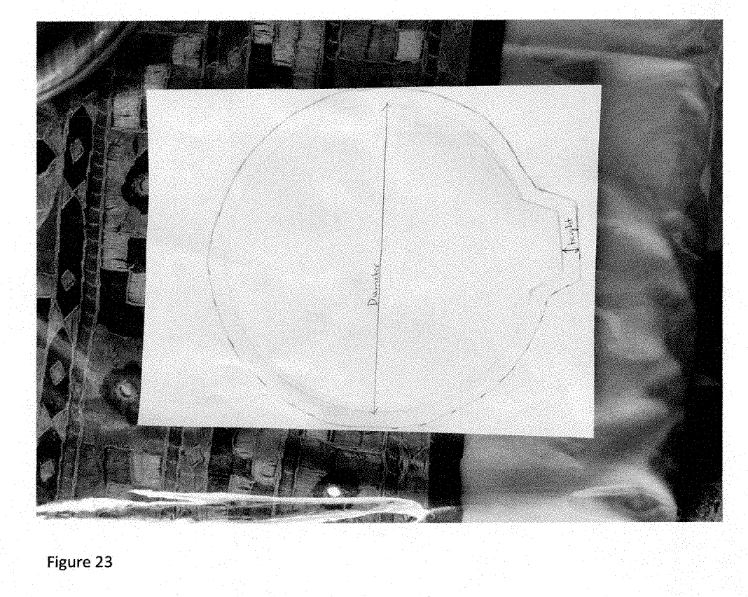

FIG. 1 shows one design of the trash bin cover in cyan. The shape of the cover is circular in order to fit trash-bins with circular lids, and the cover can be made in different sizes in the same shape. FIG. 1 shows the top view of the cover that when slipped on the trash bin lid will face outside away from the trash bin lid. FIG. 2 shows the same circular, cyan trash bin cover in FIG. 1 in a different position to showcase how the cover will be placed on the lid. The cover is shown to be of a design in which the cover is slipped on the lid through the opening shown to completely cover the trash bin lid. FIG. 3 shows the bottom of the cover that when slipped on the trash bin will face the trash inside the trash bin. FIG. 4 shows the same shaped trash bin cover as in FIG. 1 only in a different color, white, slipped on the trash bin lid that it was intended for. As stated in the description of FIG. 1, the trash bin cover can be made bigger or smaller in the same shape to completely cover trash bins with circular lids. FIG. 4 shows the top of the trash bin cover when slipped on the trash bin lid. FIG. 5 shows the bottom of the same trash bin cover in FIG. 4. FIG. 6 shows the same circular shaped trash bin cover in the previous figures in different colors laid out on a table to demonstrate the various colors that the trash bin lid can come in. FIG. 7 shows a new, differently designed trash bin cover than that shown in FIGS. 1 through 6. This design features an adjustable version of the circular trash bin cover with no top portion, only a bottom that covers the bottom of the trash bin lid from the trash in the trash bin. FIG. 8 shows the same trash bin cover in FIG. 7 in a different angle as the lid is raised with the cover on it. FIG. 9 shows the bottom of the trash bin cover in FIG. 7 and how it completely covers the bottom of the trash bin lid. FIG. 10 shows another variation of the adjustable one-sided trash bin cover as in FIG. 9. FIG. 11 shows the same trash bin cover as in FIG. 10 at a different angle. FIG. 12 shows the same trash bin cover as in FIG. 9 on top of the trash bin lid without being slipped on the trash bin lid, and scrunched up. FIG. 13 shows the underside of the trash bin cover in FIG. 10 and its snug fit on this circular trash bin lid. FIG. 14 shows the same trash bin cover in FIG. 13, but focused on the adjustable string that adjusts the trash bin cover to fit the lid of this circular trash bin and how it can be fastened by tying the two ends of the string together behind the mechanism for lifting the lid up. FIG. 15 shows the same trash bin cover as in FIG. 14 from the top of the trash bin lid and shows how the trash bin cover can be fastened to the trash bin lid by tying the adjustable string ends together. FIG. 16 shows a variation of the trash bin cover in FIG. 5 that completely covers the lid and also has a handle on the outside part of the trash bin cover in order to allow the user to easily lift the lid of the trash bin without getting their hands dirty if there is no mechanism by which the trash bin lid can be lifted by a lever activated by putting pressure on through use of one's foot or hand. FIG. 17 demonstrates the utility of the trash bin cover in FIG. 16 with a handle by showing the ease by which to lift the trash bin lid to dispose of trash without getting one's hands dirty. FIG. 18 shows the general dimensions and shape of another trash bin lid cover, specifically designed for rectangular and square-like trash bins. The dimensions of the this trash bin cover can be adjusted for larger and smaller rectangular or square-like trash bin lids, and can come in a variety of colors. FIG. 19 shows the general dimensions and shape for an elongated or oval trash bin lid that can be adjusted for larger or smaller trash bin lids and comes in a variety of colors. FIG. 20 shows another drawing for the dimensions and general shape for a rectangular or square-like trash bin cover as in FIG. 18. FIG. 21 shows the general dimensions and shape for an elongated or oval trash bin lid as in FIG. 19. FIG. 22 shows another drawing for the dimensions and general shape for a rectangular or square-like trash bin cover as in FIG. 18. FIG. 23 shows the schematics for a circular trash bin cover as in FIG. 5 that can be adjusted for different circular trash bin lid sizes and comes in a variety of colors.

The substitute specification contains no new matter.

Amendment Portion

The description below of the individual figures is added text to further clarify the invention, and FIGS. 24 to 42 have been added for clarification of the invention.

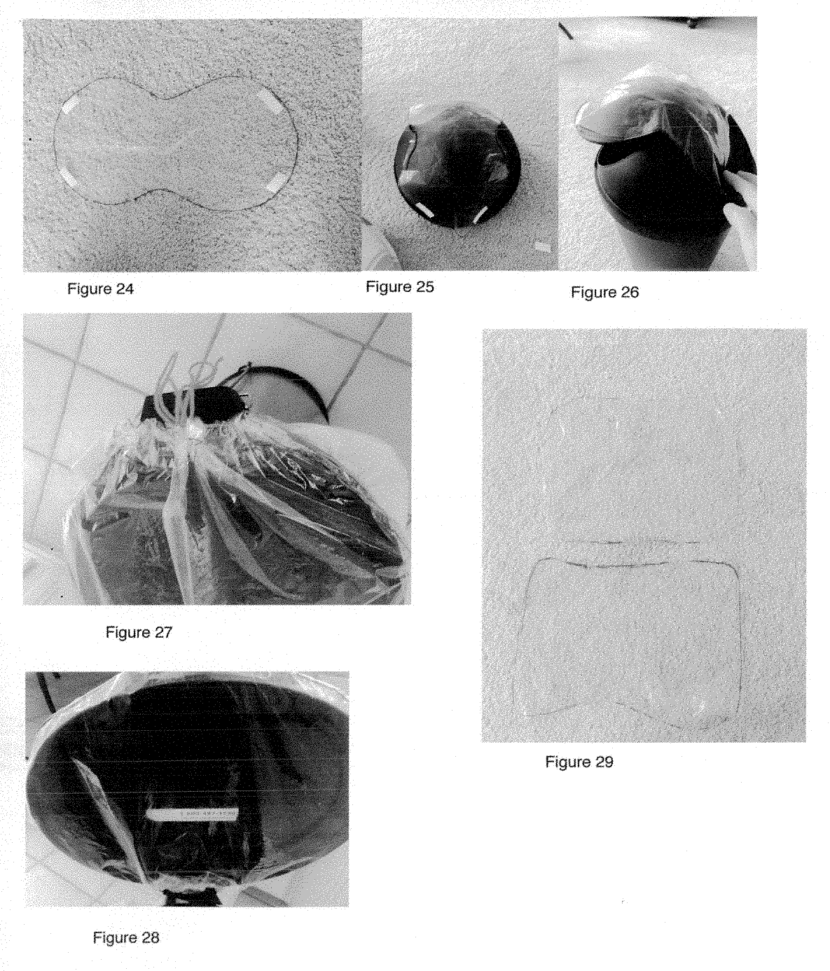

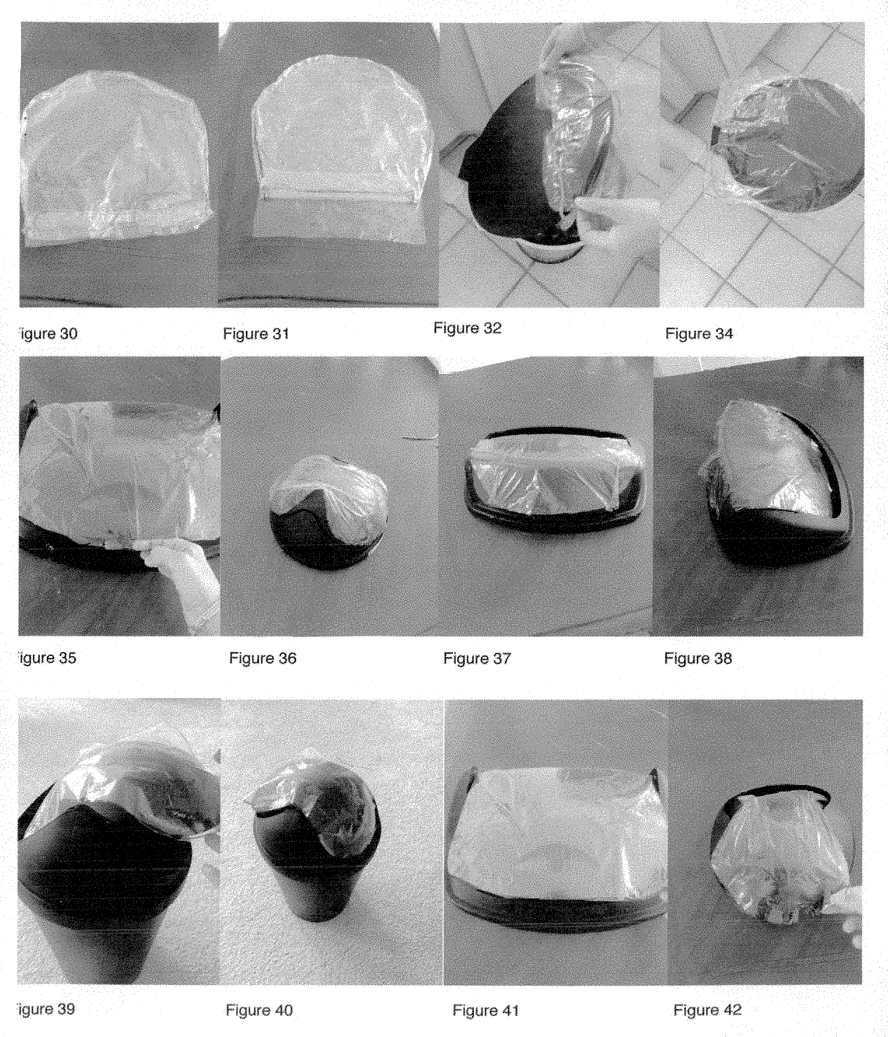

FIG. 24 is an outline of another trash-bin lid design derived from the original for round, spherical trash-bin lids that have a flip lid function. FIGS. 25, 36, and 40 shows a small trash-bin with a flip lid installed with the new trash-bin lid from FIG. 24. FIGS. 26, 39, and 42 show the utility and ease of use of this trash-bin lid. FIG. 29 shows the design of another trash-bin lid design derived from the original for trash-bins that have a square and rectangular shape flip lid. FIGS. 35, 37, 38, and 41 show the trash-bin lid cover in FIG. 29 fitted on the trash-bin lid for which it was intended. FIGS. 30 and 31 show an alternation on the original drawstring trash-bin lid cover design and its overall dimensions and shape. FIG. 32 showcases how the trash-bin lid cover from FIG. 30 is fitted over the trash-bin lid. FIG. 34 shows the trash bin lid cover from FIG. 30 fitted on the trash-bin untied. FIGS. 27 and 28 are images of the trash-bin cover fitted on the trash-bin lid at different angles with it being properly fastened with the tie encircling the cover.

1. I, Iram Yusuf, solely claim that this garbage lid invention which I have created and specified is solely my own work, creation, and invention. As to my knowledge, there is no such product in the market for domestic or commercial use. I invented this product July 2017 for my own domestic use.
